(19) United States
(12) Patent Application Publication
(10) Pub. No.: US 2016/0232644 A1
(43) Pub. Date: Aug. 11, 2016

(54) DIFFERENCE IMAGE COMPRESSION

(71) Applicant: Visual Supply Company, Oakland, CA (US)

(72) Inventors: Zachary Daniel Hodges, Orinda, CA (US); Robert A. Newport, Oakland, CA (US)

(21) Appl. No.: 14/617,244

(22) Filed: Feb. 9, 2015

(51) Int. Cl. G06T 1/60; H04N 19/182; H04N 19/137; G06F 17/30; G06T 5/50

(52) U.S. Cl. CPC G06T 1/60; G06F 17/3028; G06T 5/50; H04N 19/137; H04N 19/182

(57) ABSTRACT

A system, a machine-readable storage medium storing instructions, and a computer-implemented method are described herein for a Difference File Generator that receives at least one edit to at least one pixel of a source image file. The Difference File Generator generates a first edited version of the source image file having at least one edited pixel. Each edited pixel comprises a pixel resulting from the at least one edit to a respective pixel of the source image file. The Difference File Generator generates a pixel difference file comprising pixel difference data. The Pixel difference data indicates a difference between each respective pixel of the source image file and a corresponding edited pixel in the first edited version of the source image file.

### TECHNICAL FIELD

The present application relates generally to systems and methods for editing image files and more specifically to systems and methods for generating information describing results of user edits to a source image file.

### BACKGROUND

The rise of the computer age has resulted in a wide variety of electronic devices. One common type of electronic device is a personal electronic device that is intended to be carried around by a user, such as a smart phone, a tablet computer, or a smart watch. Each personal device has a large number of capabilities that increase its usefulness.

One common capability provided by personal devices is image editing functionality. Cameras that are built into a personal electronic device allow the personal electronic device to capture visual data for picture and videos. That data can be saved on the personal electronic device and displayed on the display associated with the device (e.g., a touch screen for a tablet computer). In some cases the personal electronic devices can modify the visual data.

### BRIEF DESCRIPTION OF THE DRAWINGS

Some embodiments are illustrated by way of example and not limitation in the figures of the accompanying drawings.

FIG. 1 is a network diagram illustrating a network environment suitable for image processing, according to some example embodiments.

FIG. 2 is a block diagram illustrating components of a computing device suitable for a Difference File Generator, according to some example embodiments.

FIG. 3 is a block diagram illustrating the creation and caching of a first pixel difference file, according to some example embodiments.

FIG. 4 is a block diagram illustrating the creation and caching of a second pixel difference file, according to some example embodiments.

FIG. 5 is a block diagram illustrating the creation of an edited image by applying a pixel difference file to a source image, according to some example embodiments.

FIG. 6 is a flowchart illustrating a method for cached image processing, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to a Difference File Generator. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In various embodiments, the Difference File Generator receives at least one edit to at least one pixel of a source image file. The Difference File Generator generates a first edited version of the source image file having at least one edited pixel. Each edited pixel comprises a pixel resulting from the at least one edit to a respective pixel of the source image file. The Difference File Generator generates a pixel difference file comprising pixel difference data. The pixel difference data indicates a difference between each respective pixel of the source image file and a corresponding edited pixel in the first edited version of the source image file.

In one or more embodiments, the Difference File Generator receives one or more edits to a source image file. The one or more edits can be a user-selection of any type of image editing tool that allows for image filtering and/or image modification. For example, a filter can change a hue of one or more colors present in the source image file. Based on the received edits, the Difference File Generator creates an edited version of the source image file. The Difference File Generator compares the source image file and the edited version of the source image file. Based on the comparison, the Difference File Generator creates a pixel difference file.

The pixel difference file includes pixel difference data that correspond to one or more pixels in the source image file and the edited version of the source image file. The pixel difference file indicates a difference between pixels in the source image file and the edited version of the source image file. For example, for a first pixel from the source image file, a user-selected edit may modify the first pixel such that it has a modified color in the edited version of the source image file. The Difference File Generator generates first pixel difference data that numerically represents a difference between the first pixel's original color and the first pixel's modified color in the edited version of the source image file. It is understood that the embodiments described herein are not limited pixel difference data that describes a change in pixel color. The pixel difference data can describe a change in pixel location and/or pixel size.

In addition, a user-selected edit may modify a second pixel in the source image file. In various embodiments, the edit made to the first pixel may be different than an the edit made to the second pixel. The Difference File Generator generates second pixel difference data for the pixel difference file that numerically represents a difference between the second pixel in the source image file a modified pixel that results from applying the user-selected edit to the second pixel.

The Difference File Generator stores the pixel difference file in cache memory. By storing the pixel difference file in cache memory, the Difference File Generator allows for cache-based image processing.

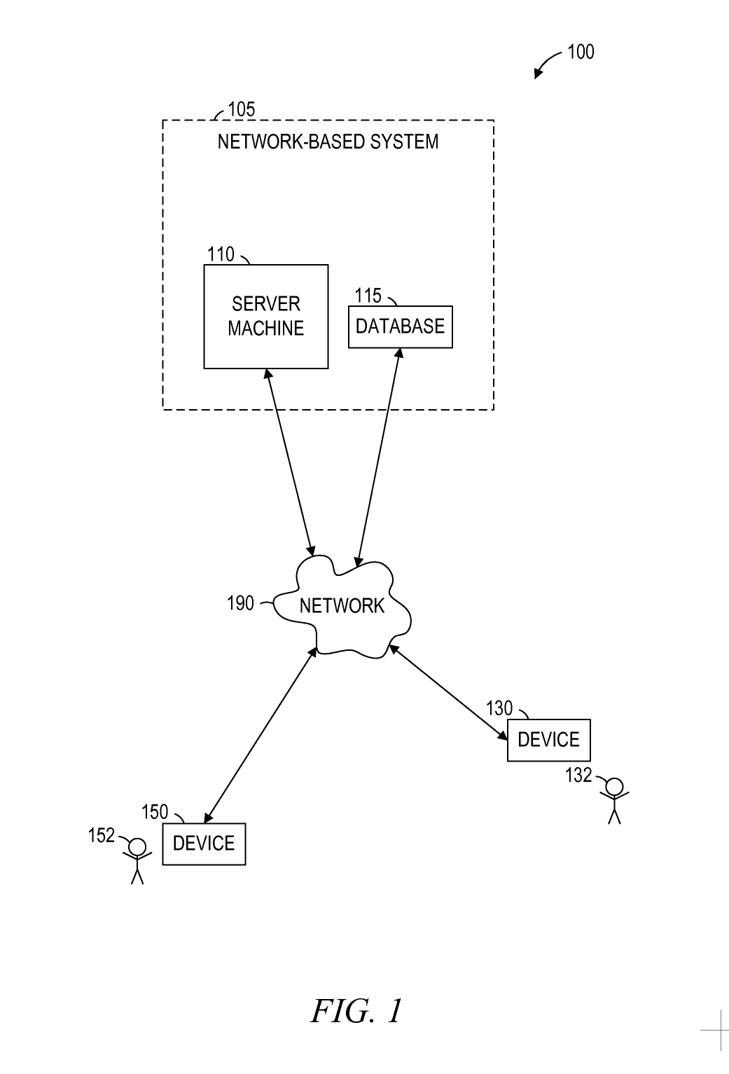

FIG. 1 is a network diagram illustrating a network environment 100 suitable for image processing, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the devices 130 and 150). The server machine 110 and the devices 130 and 150 may each be implemented in a computer system, in whole or in part, as described below with respect to FIG. 11.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

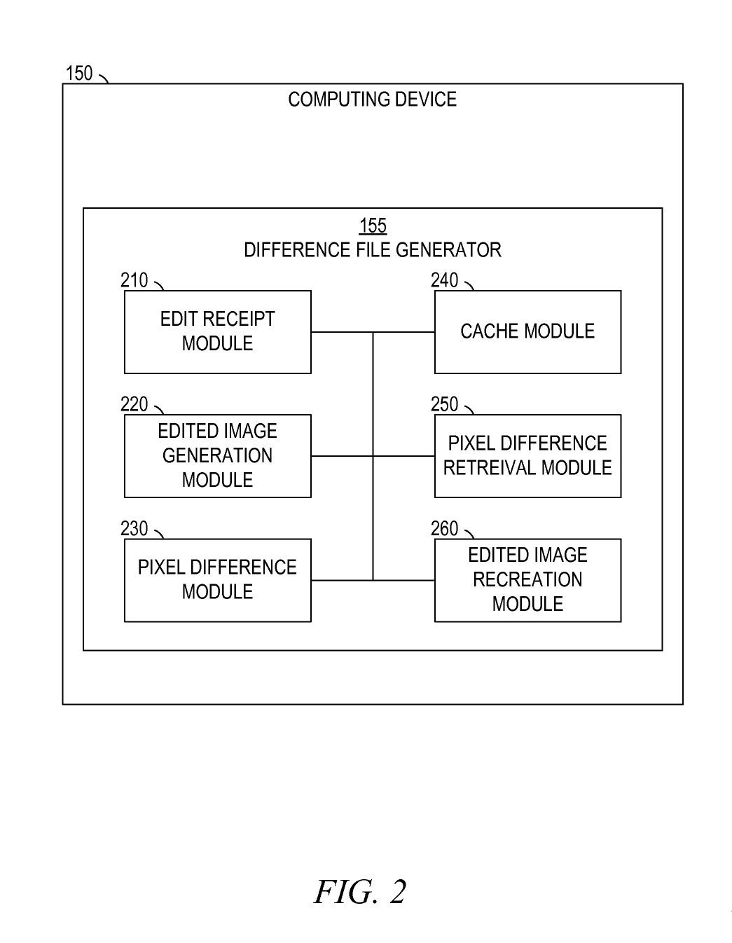

FIG. 2 is a block diagram illustrating components of the computing device 150, according to some example embodiments. The computing device 150 is shown as including a Difference File Generator 155. The Difference File Generator includes various modules, such as an edit receipt module 210, an edited image generation module 220, a pixel difference module 230, a cache module 240, a pixel difference retrieval module 250 and an edited image recreation module 260, all configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the edit receipt module 210 is a hardware-implemented module that controls, manages and stores information related to receiving one or more user-selected edits to a source image file.

In various example embodiments, the edited image generation module 220 is a hardware-implemented module that controls, manages and stores information related to generating an edited version of the source image file according to the received user-selected edits.

In various example embodiments, the pixel difference module 230 is a hardware-implemented module that controls, manages and stores information related to generating a pixel difference file that include pixel difference data. The pixel difference data numerically represents differences between respective pixels in the source image file and correspond edited pixels in the edited version of the source image file.

In various example embodiments, the cache module 240 is a hardware-implemented module that controls, manages and stores one or more pixel difference files.

In various example embodiments, the pixel difference retrieval module 250 is a hardware-implemented module that controls, manages and stores information related to retrieving a pixel difference file from the cache module 204.

In various example embodiments, the edited image recreation module 260 is a hardware-implemented module that controls, manages and stores information applying a retrieved pixel difference file to a source image file in order to recreate the edited version of the source image file without having to execute the user-selected edits.

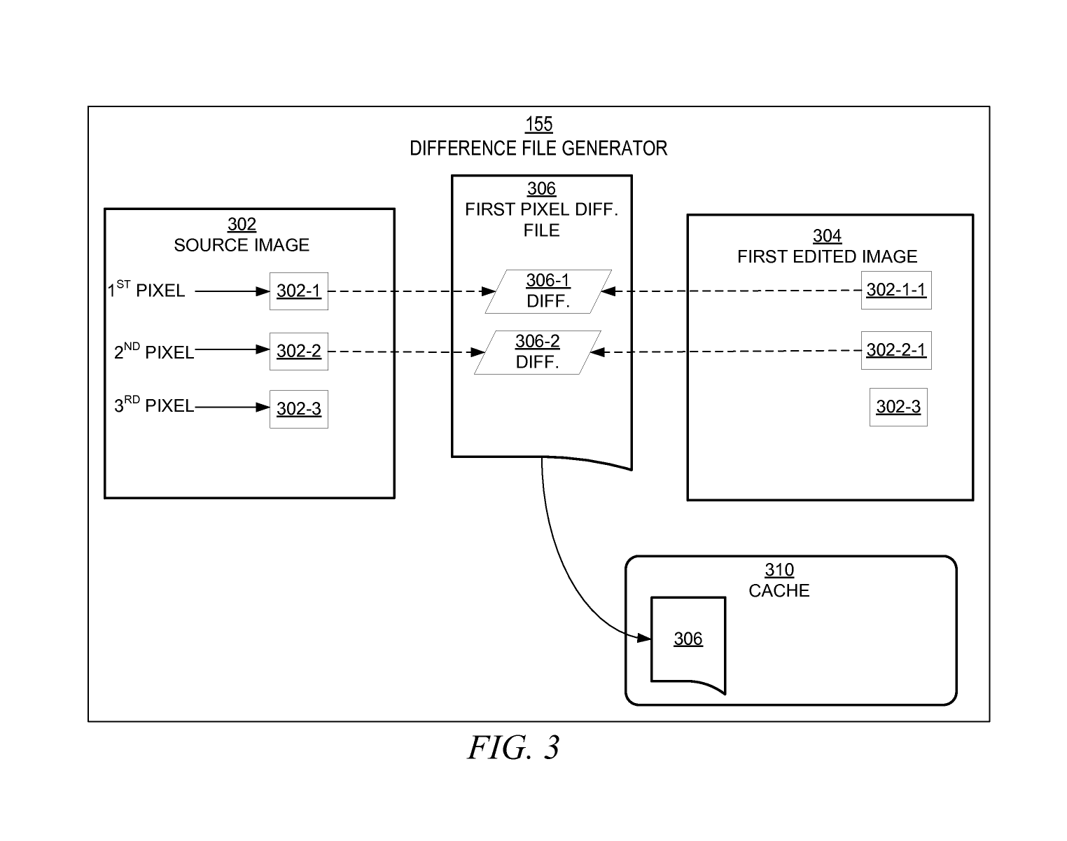

FIG. 3 is a block diagram illustrating the creation and caching of a first pixel difference file, according to some example embodiments. A source image 302 is made up of a plurality of pixels. The plurality of pixels includes at least a first pixel 302-1, a second pixel 302-2 and a third pixel 302-3.

The Difference File Generator (“DFG”) 155 receives one or more user-selected applied to the source image 302. For example, a first user-selected edit modifies the first pixel 302-1 and a second user-selected edit modifies the second pixel 302-2. Based on the received edits, the DFG 155 generates a first edited version of the source image 304. The first edited version of the source image 304 includes an edited version of the first pixel 302-1-1, an edited version of the second pixel 302-2-1 and the third pixel 302-3.

The DFG 155 compares the edited version of the first pixel 302-1-1 to the first pixel 302-1 and generates first pixel difference data 306-1. The first pixel difference data 306-1 numerically represents a difference between the edited version of the first pixel 302-1-1 and the first pixel 302-1. The DFG 155 also compares the edited version of the second pixel 302-2-1 to the second pixel 302-2 and generates second pixel difference data 306-2. The second pixel difference data 306-2 numerically represents a difference between the edited version of the second pixel 302-2-1 and the second pixel 302-2.

The DFG 155 generates a first pixel difference file 306, which includes the first and second pixel difference data 306-1, 306-2. The DFG 155 stores the first pixel difference file 306 in cache memory 310.

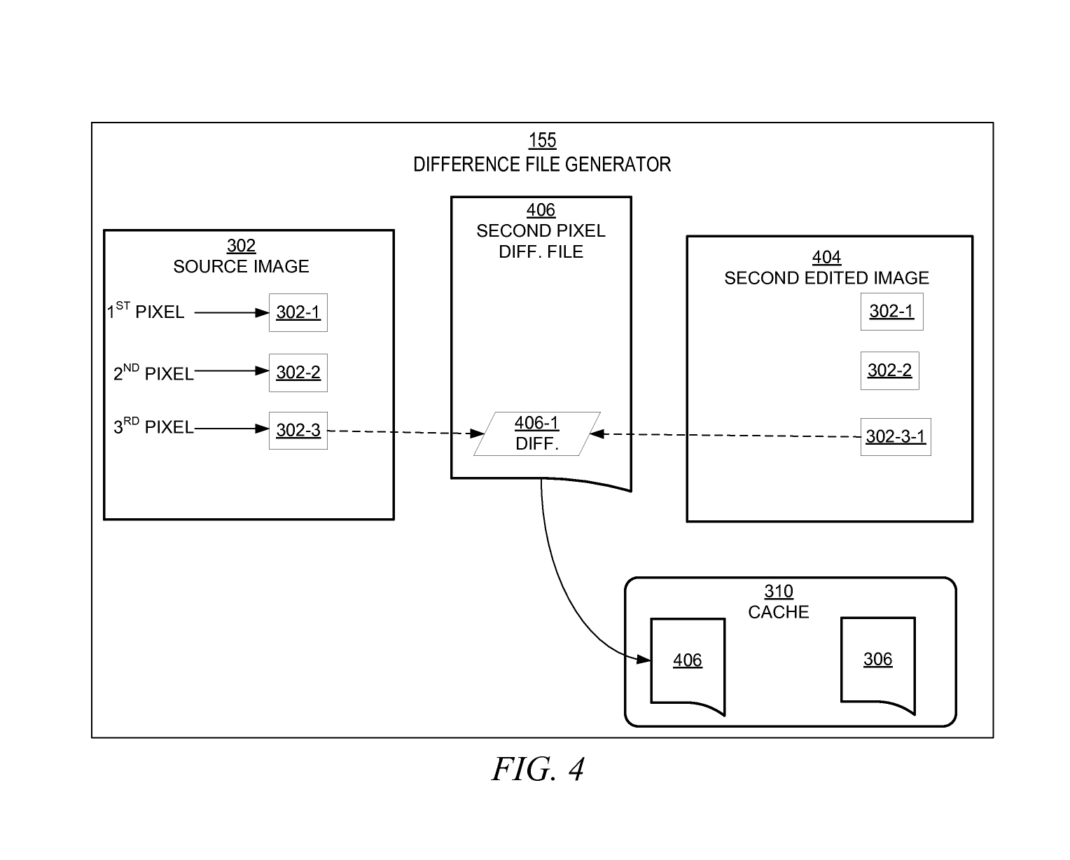

FIG. 4 is a block diagram illustrating the creation and caching of a second pixel difference file, according to some example embodiments.

The Difference File Generator (“DFG”) 155 receives one or more user-selected applied to the same source image 302. For example, a third user-selected edit modifies the third pixel 302-3, but leaves the first and second pixels 302-1, 302-2 unmodified. Based on the received edits, the DFG 155 generates a second edited version of the source image 404. The second edited version of the source image 404 includes an edited version of the third pixel 302-3-1, as well as the first and second pixels 302-1, 302-2

The DFG 155 compares the edited version of the third pixel 302-3-1 to the third pixel 302-3 and generates third pixel difference data 406-1. The third pixel difference data 406-1 numerically represents a difference between the edited version of the third pixel 302-3-1 and the third pixel 302-3. The DFG 155 generates a second pixel difference file 406, which includes the third pixel difference data 406-1. The DFG 155 stores the second pixel difference file 406 in in cache memory 310 along with the previously-generated first pixel difference file 306.

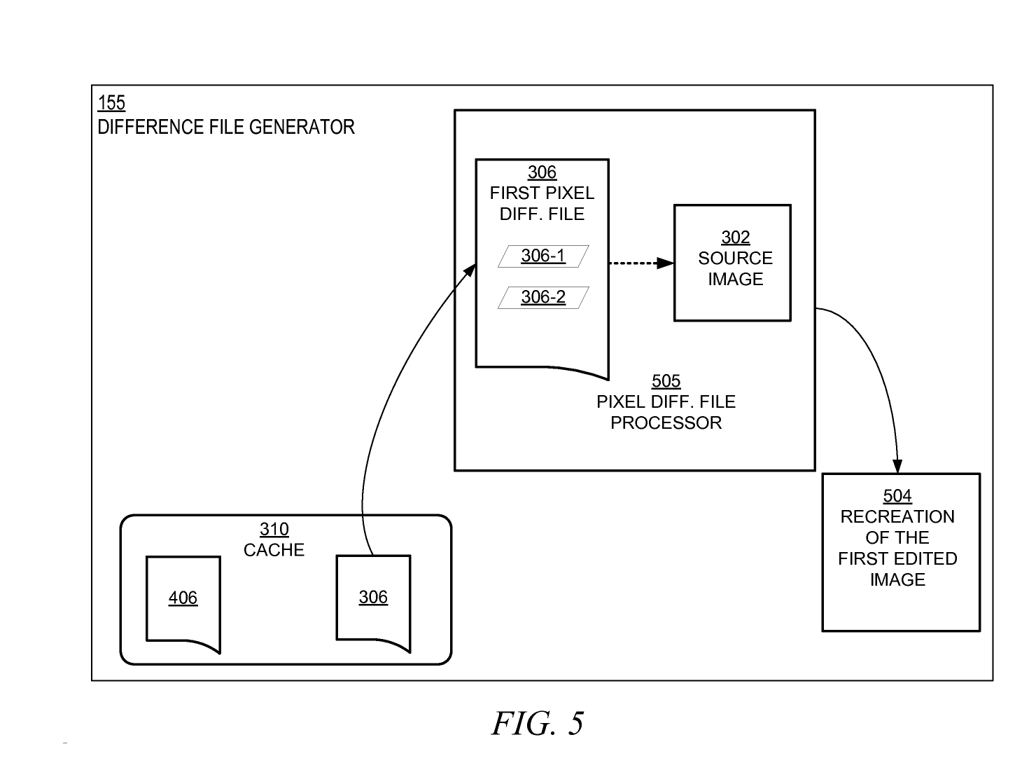

FIG. 5 is a block diagram illustrating the creation of an edited image by applying a pixel difference file to a source image, according to some example embodiments.

The DFG 155 includes a pixel difference file processor 505 to apply the first pixel difference file 306 to the source image 302. For example, in one embodiment, the first pixel 302-1 has a pixel color value of “249” and the edited version of the first pixel 302-1-1 has a pixel color value of “246. Therefore, the first pixel difference data 306-1 in the first pixel difference file 306 has a value of “−3”. In addition, the second pixel 302-2 has a pixel color value of “237” and the edited version of the second pixel 302-2-1 has a pixel color value of “236”. Therefore, the second pixel difference data 306-2 in the first pixel difference file 306 has a value of

The pixel difference file processor 505 applies the first and second pixel difference data 306-1, 306-2 from the first pixel difference file 306 to the source image 302. The color value of the first pixel 302-1 is adjusted from “249” to “246” and the color value of the second pixel 302-2 is adjusted from “237” to “236”. Based on the adjustments made to the color values of the first and second pixels 302-1, 302-2, the pixel difference file processor 505 generates a recreation of the first edited image 504 without having to execute the user-selected edits that created the first edited image 304.

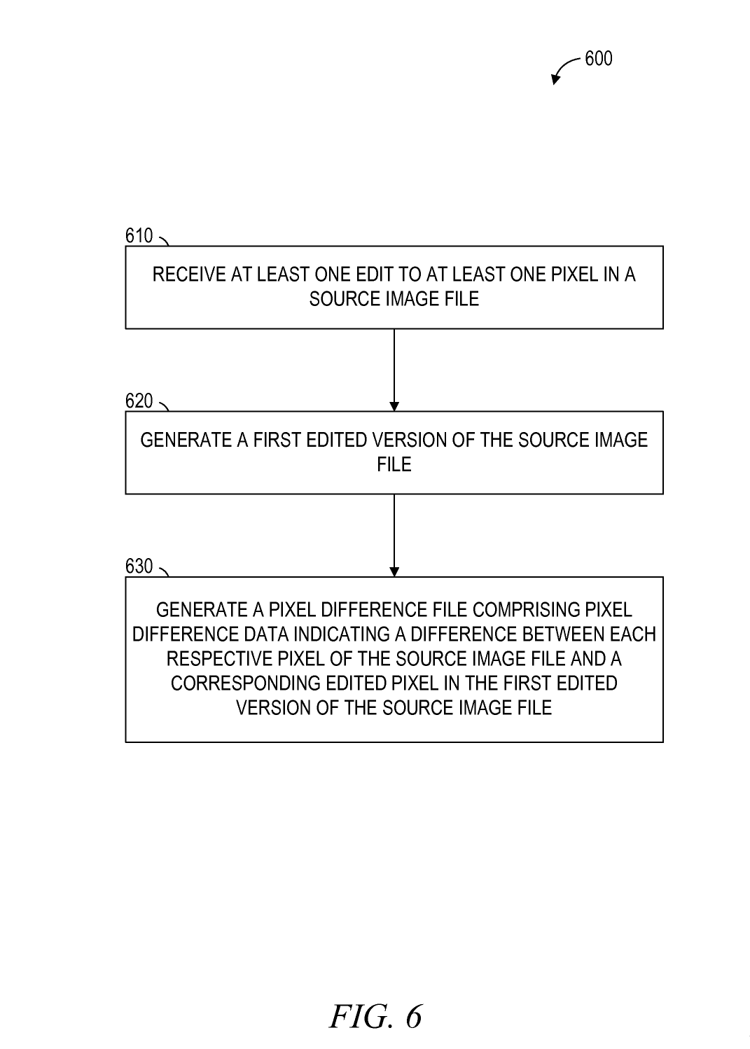

FIG. 6 is a flowchart illustrating a method 600 for cached image processing, according to some example embodiments. Operations in the method 600 may be performed by the device 150, using modules described above with respect to FIG. 2. As shown in FIG. 6, the method 600 includes operations 610, 620 and 630.

At operation 610, the DFG 155 receives at least one edit to at least one pixel in a source image file. In various embodiments, a first edit applied to a first pixel of the source image file can be difference than a second edit applied to a second pixel of the source image file.

At operation 620, the DFG 155 generates a first edited version of the source image file. Each edited pixel in the first edited version of the source image file comprises a pixel resulting from an edit(s) to a respective pixel of the source image file.

At operation 630, the DFG 155 generates a pixel difference file. The pixel difference file comprises pixel difference data that indicates a difference between each respective pixel of the source image file and a corresponding edited pixel in the first edited version of the source image file.

In some embodiments, to generate the pixel difference file, the DFG 155 compares a first pixel of the source image file and a first edited pixel. The first edited pixel resulting from an edit(s) applied to the first pixel. The DFG 155 generate first pixel difference data that numerically represents a difference between the first pixel and the first edited pixel. The DFG 155 incorporates the first pixel difference data in the pixel difference file.

According to various example embodiments, one or more of the methodologies described herein may facilitate a Difference File Generator.

When these effects are considered in aggregate, one or more of the methodologies described herein may obviate a need for certain efforts or resources that otherwise would be involved in one or more embodiments of the Difference File Generator. Efforts expended by a user in generating a pixel difference file may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

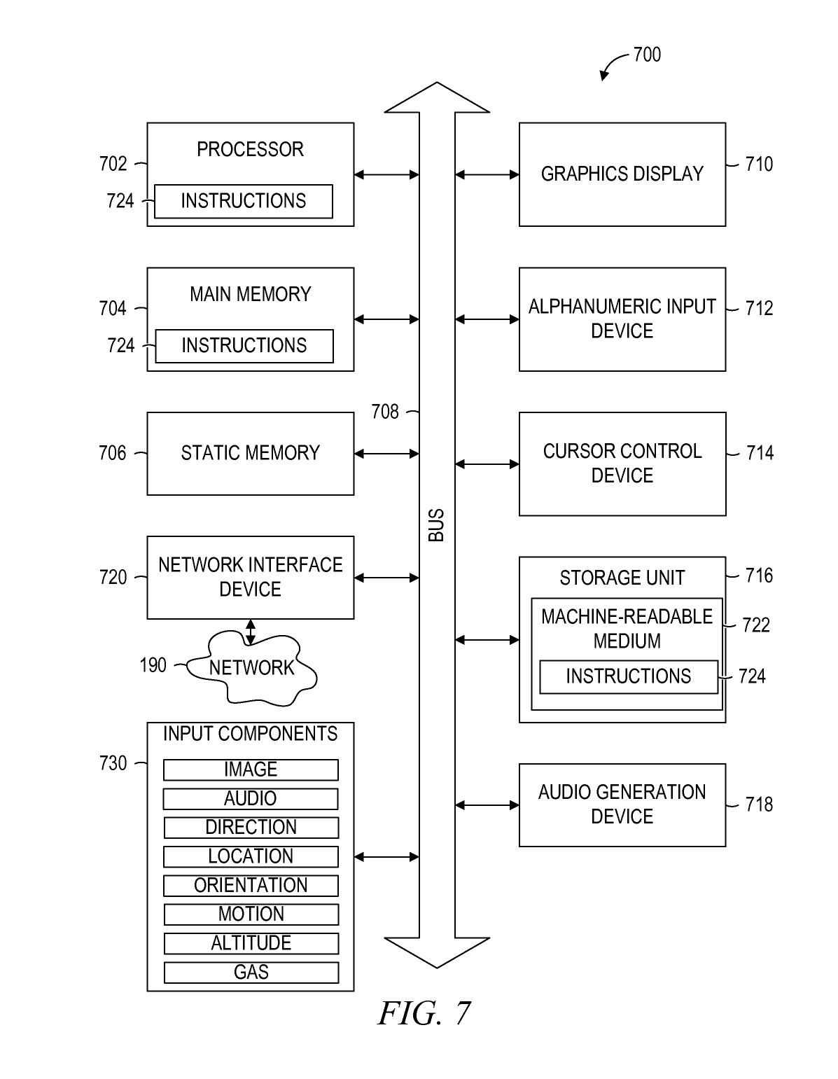

FIG. 7 is a block diagram illustrating components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media). The instructions 724 may be transmitted or received over the network 190 via the network interface device 720. For example, the network interface device 720 may communicate the instructions 724 using any one or more transfer protocols (e.g., hypertext transfer protocol (HTTP)).

In some example embodiments, the machine 700 may be a portable computing device, such as a smart phone or tablet computer, and have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method, comprising:
receiving at least one edit to at least one pixel of a source image file;
generating a first edited version of the source image file having at least one edited pixel, each edited pixel comprising a pixel resulting from the at least one edit to a respective pixel of the source image file; and
generating a pixel difference file comprising pixel difference data indicating a difference between each respective pixel of the source image file and a corresponding edited pixel in the first edited version of the source image file.

2. The computer-implemented method of claim 1, wherein generating a pixel difference file comprising pixel difference data indicating a difference between each respective pixel of the source image file and a corresponding edited pixel comprises:
comparing a first pixel of the source image file and a first edited pixel, the first edited pixel resulting from at least one edit applied to the first pixel;
generating first pixel difference data numerically a representing a difference between the first pixel and the first edited pixel; and
incorporating the first pixel difference data in the pixel difference file.

3. The computer-implemented method of claim 2, wherein generating a pixel difference file comprising pixel difference data indicating a difference between each respective pixel of the source image file and a corresponding edited pixel comprises:
comparing a second pixel of the source image file and a second edited pixel, the second edited pixel resulting from at least one edit applied to the second pixel, the at least one edit applied to the second pixel different than the at least one edit applied to the first pixel;
generating second pixel difference data numerically a representing a difference between the second pixel and the second edited pixel; and
incorporating the second pixel difference data in the pixel difference file.

4. The computer-implemented method of claim 2, wherein generating first pixel difference data comprises at least one of:
representing a difference in pixel color between the first pixel and the first edited pixel;
representing a difference in pixel size between the first pixel and the first edited pixel; and
representing a difference in pixel location between the first pixel and the first edited pixel.

5. The computer-implemented method of claim 2, comprising:
storing the pixel difference file in cache memory.

6. The computer-implemented method of claim 1, comprising:
accessing the pixel difference file in the cache memory;
applying the pixel difference file to the source image file; and
based on applying the pixel difference file, generating a second edited version of the source image file, wherein the second edited version of the source image file is the same as the first edited version of the source image file.

7. The computer-implemented method of claim 6, wherein applying the pixel difference file to the source image file comprises:
accessing the difference between the first pixel and the first edited pixel in the first pixel difference data;
generating an adjusted pixel based on adjusting the first pixel in the source image file according to the difference in the first pixel difference data; and
wherein generating a second edited version of the source image file comprises: incorporating the adjusted pixel in the second edited version of the source image file.

8. A non-transitory computer-readable medium storing executable instructions thereon, which, when executed by a processor, cause the processor to perform operations including:
receiving at least one edit to at least one pixel of a source image file;
generating a first edited version of the source image file having at least one edited pixel, each edited pixel comprising a pixel resulting from the at least one edit to a respective pixel of the source image file; and
generating a pixel difference file comprising pixel difference data indicating a difference between each respective pixel of the source image file and a corresponding edited pixel in the first edited version of the source image file.

9. The non-transitory computer-readable medium of claim 8, wherein generating a pixel difference file comprising pixel difference data indicating a difference between each respective pixel of the source image file and a corresponding edited pixel comprises:
comparing a first pixel of the source image file and a first edited pixel, the first edited pixel resulting from at least one edit applied to the first pixel;
generating first pixel difference data numerically a representing a difference between the first pixel and the first edited pixel; and
incorporating the first pixel difference data in the pixel difference file.

10. The non-transitory computer-readable medium of claim 9, wherein generating a pixel difference file comprising pixel difference data indicating a difference between each respective pixel of the source image file and a corresponding edited pixel comprises:
comparing a second pixel of the source image file and a second edited pixel, the second edited pixel resulting from at least one edit applied to the second pixel, the at least one edit applied to the second pixel different than the at least one edit applied to the first pixel;
generating second pixel difference data numerically a representing a difference between the second pixel and the second edited pixel; and
incorporating the second pixel difference data in the pixel difference file.

11. The non-transitory computer-readable medium of claim 9, wherein generating first pixel difference data comprises at least one of:
representing a difference in pixel color between the first pixel and the first edited pixel;
representing a difference in pixel size between the first pixel and the first edited pixel; and
representing a difference in pixel location between the first pixel and the first edited pixel.

12. The non-transitory computer-readable medium of claim 9, comprising:
storing the pixel difference file in cache memory.

13. The non-transitory computer-readable medium of claim 8, comprising:
accessing the pixel difference file in the cache memory;
applying the pixel difference file to the source image file; and
based on applying the pixel difference file, generating a second edited version of the source image file, wherein the second edited version of the source image file is the same as the first edited version of the source image file.

14. The non-transitory computer-readable medium of claim 13, wherein applying the pixel difference file to the source image file comprises:
accessing the difference between the first pixel and the first edited pixel in the first pixel difference data;
generating an adjusted pixel based on adjusting the first pixel in the source image file according to the difference in the first pixel difference data; and
wherein generating a second edited version of the source image file comprises: incorporating the adjusted pixel in the second edited version of the source image file.

15. A computer system comprising:
a processor;
a memory device holding an instruction set executable on the processor to cause the computer system to perform operations comprising:
receiving at least one edit to at least one pixel of a source image file;
generating a first edited version of the source image file having at least one edited pixel, each edited pixel comprising a pixel resulting from the at least one edit to a respective pixel of the source image file; and
generating a pixel difference file comprising pixel difference data indicating a difference between each respective pixel of the source image file and a corresponding edited pixel in the first edited version of the source image file.

16. The computer system of claim 15, wherein generating a pixel difference file comprising pixel difference data indicating a difference between each respective pixel of the source image file and a corresponding edited pixel comprises:
comparing a first pixel of the source image file and a first edited pixel, the first edited pixel resulting from at least one edit applied to the first pixel;
generating first pixel difference data numerically a representing a difference between the first pixel and the first edited pixel; and
incorporating the first pixel difference data in the pixel difference file.

17. The computer system of claim 16, wherein generating a pixel difference file comprising pixel difference data indicating a difference between each respective pixel of the source image file and a corresponding edited pixel comprises:
comparing a second pixel of the source image file and a second edited pixel, the second edited pixel resulting from at least one edit applied to the second pixel, the at least one edit applied to the second pixel different than the at least one edit applied to the first pixel;
generating second pixel difference data numerically a representing a difference between the second pixel and the second edited pixel; and
incorporating the second pixel difference data in the pixel difference file.

18. The computer system of claim 16, wherein generating first pixel difference data comprises at least one of:
representing a difference in pixel color between the first pixel and the first edited pixel;
representing a difference in pixel size between the first pixel and the first edited pixel; and
representing a difference in pixel location between the first pixel and the first edited pixel.

19. The computer system of claim 16, comprising:
storing the pixel difference file in cache memory.

20. The computer system claim 20, comprising:
accessing the pixel difference file in the cache memory;
applying the pixel difference file to the source image file, wherein applying the pixel difference file to the source image file comprises:
accessing the difference between the first pixel and the first edited pixel in the first pixel difference data;
generating an adjusted pixel based on adjusting the first pixel in the source image file according to the difference in the first pixel difference data; and
based on applying the pixel difference file, generating a second edited version of the source image file, wherein the second edited version of the source image file is the same as the first edited version of the source image file, wherein generating a second edited version of the source image file comprises:
incorporating the adjusted pixel in the second edited version of the source image file.
